(19) United States
(12) Patent Application Publication
(10) Pub. No.: US 2010/0039952 A1
(43) Pub. Date: Feb. 18, 2010

(54) SYSTEM FOR MONITORING, CONTROL AND DATA ACQUISITION OF TECHNICAL PROCESSES

(76) Inventor: Christian LENZ, Hamburg (DE)

Correspondence Address: NOTARO & MICHALOS P.C., 100 DUTCH HILL ROAD, SUITE 110, ORANGEBURG, NY, 10962-2100, US

(21) Appl. No.: 12/540,535

(22) Filed: Aug. 13, 2009

(30) Foreign Application Priority Data
Aug. 13, 2008 (DE) 10 2008 038 968.4

(51) Int. Cl. H04L 12/26

(52) U.S. Cl. 370/252

(57) ABSTRACT

In order to provide a system (1) for monitoring, control and data acquisition of technical processes, comprising at least one communication unit (12) as an interface for bidirectional data exchange with external units (2, 3), which allows comprehensive monitoring, control and data acquisition of a technical process incorporating additional far-from process data, it is proposed that at least one communication unit (12) is configured for communication with at least one external electronic process database (3) and at least one communication unit (12) is configured for communication with at least one external technical control unit (2).

### FIELD AND BACKGROUND OF THE INVENTION

The present invention relates to a system for monitoring, control and data acquisition of technical processes, comprising at least one communication unit as an interface for bidirectional data exchange with external units.

The present invention equally relates to a method for monitoring, control and data acquisition of technical processes by means of bidirectional data exchange with external units.

Such a system and method as a concept for monitoring and controlling technical processes is frequently known under the English term supervisory control and data acquisition (SCADA).

A SCADA system of the type specified initially is used to monitor the installation of close-to-process controls and to visualise process data. In this case, most of the actual regulation is carried out automatically by so-called remote terminal units (RTU) or by programmable logic controller (PLC) or other close-to-process automations. These known systems or methods serve to optimise the function of the close-to-process automation, in particular to predefine or to receive control variables and desired values. Usually in the known systems and methods of the type specified initially, the data received from the close-to-process equipment, possibly status information such as, for example, switch positions, is received and then presented in a user-friendly display. This allows the user to intervene in the process in a controlling manner.

The systems typically implement a data base which contains data points. A data point contains, for example, an input or output value which is monitored and controlled by the system. Usually in the prior art, data points are treated as a combination of values with a time stamp. A series of data points then allows a historical evaluation.

A disadvantage with the known systems, however is that a comprehensive monitoring of the technical processes incorporating all relevant data and a standard system is not usually possible. For example, many data which characterise the process are available in commercial databases, for example, SAP. For example, data about sold quantities of a product can be stored there. However, an evaluation of sold quantities of a product also makes it possible to predict, for example, the level of a container storing this product in the process. In addition, technical data such as, for example, stock lists, order numbers, operating instructions, are also conventionally usually stored in separate databases. These quantities are also important for the comprehensive monitoring of a technical process.

There is therefore a need for a system and method of the type specified initially which allows comprehensive monitoring, control and data acquisition of a technical process incorporating additional far-from-process data. The object of the present invention is therefore to propose such a system and such a method.

### SUMMARY OF THE INVENTION

According to the invention, this object is achieved in a generic system in that at least one communication unit is configured for communication with at least one external electronic process database and with at least one communication unit for communication with at least one external technical control unit. It is therefore proposed according to the invention that a conventional SCADA system is further developed in such a manner that it allows data exchange both with, for example, close-to-process programmable logic controllers and also with external databases such as SAP databases within one and the same system. A combination of automation technology and of other databases is therefore advantageously achieved according to the invention.

In an advantageous embodiment of the system according to the invention, it is provided that the communication unit is configured for addressing any external unit by means of a unique identifier, wherein identifiers for process databases are configured to be referencing to their primary key and identifiers for control units are configured to be referencing to a memory address. The incorporation of external databases into the process monitoring system is configured in a particularly favourable manner.

In an advantageous embodiment of the invention, a communication channel database is provided in which identifiers for communication with external units are stored. By this means, before beginning the actual control and monitoring of a technical process, it is possible to prepare the system for the PLC controls actually provided in the installation to be monitored and the databases additionally to be read out. During the control the invention then ensures that the system only addresses and reads out memory regions actually provided in the controls and databases.

In an advantageous embodiment of the invention, an adaptation of the system to different PLC controls of different manufacturers and/or different databases is made possible by configuring the communication unit for addressing memory regions on external units according to a standard format for all external units, in particular in SQL format. In particular SQL-like formats can be used within the scope of the invention. Databases and close-to-process technical controls then behave in the same way according to the invention with regard to the further signal processing within the system.

In a preferred embodiment of the invention, a data structure database is provided, in which data structures of external units connectable to the system are stored. In such a structure of the invention, the process data which can be read out from a control, its format and similar can be stored, for example, in a desired detailing stage. In addition, specified status messages can be assigned to process parameters read out from a PLC within the structure according to the invention.

In order to ensure a linking of data available from the external units with structure information relating to the interpretation of these data, in an embodiment of the invention means for checking a data compatibility, in particular with regard to a data format and/or a data width, are provided between elements of the data structure database and elements of the communication channel database. If the system implements a relational database, such a compatibility check can be made, in particular by means of an integrity check of the unique keys of each table. In this way, a linking of available communication channels with the matching data structures can advantageously be achieved.

The system according to the invention is further improved if a connection database is provided in which desired compatible pairs of elements of the data structure database and elements of the communication channel database are stored. The system can then be suitably configured in advance by preparing the monitoring, control and data acquisition so that during the actual monitoring operation, communication can only take place between suitable structures and channels.

In a preferred further development of the system according to the invention, a link database is provided for storing links between process data from a process database and measurement data from a technical control unit for the purpose of visualising said data. For example, data of a flow measurement read out from a PLC can be presented simultaneously with sales figures for this product stored in a SAP database in order to advantageously provide an overview of production inflow and sales outflow.

In an embodiment of the method according to the invention, each external unit is addressed by means of a unique identifier, wherein identifiers for process databases are formed from their primary key and identifiers for control units are formed from a memory address. In this way, uniform administration of process and commercial data or general technological data from a database is advantageously facilitated.

A particularly efficient embodiment of the method according to the invention provides that identifiers for data exchange with external units are stored before the beginning of monitoring, control and data acquisition in a communication channel database. According to the invention, provision is therefore made to carry out a pre-configuration of the monitoring system in order to only interlink “suitable”, i.e. compatible signals in monitoring operation using the communication channel database.

Preferably according to the invention, memory regions on external units are addressed according to a standard format for all external units, in particular, SQL format. In particular, SQL-like formats can also be used within the scope of the invention. In this way, a standardised coupling to evaluation routines is made possible. For example, in a configuration of evaluation routines, it is not necessary to take into account a priori whether this should receive values from a database or values which have been read out from a PLC as input quantities. An evaluation can thus be created and implemented in a modular manner.

In a preferred embodiment of the method according to the invention, before a data exchange, data structures of external units connectable to a system are read out from a data structure database and before each data exchange, a data compatibility, particularly with regard to a data format and/or a data width, is checked between elements in the data structure database and elements of a communication channel database, wherein a data exchange is exclusively carried out between compatible elements. The sequence of the method according to the invention in this embodiment is then similar to the sequences of a terminal board. This is because as it were, links are created between predefined data structures and relevant, i.e. compatible communication channels. In this case, a communication channel can equally well be connected to an external database or to a close-to-process PLC.

If, in another embodiment of the invention, the process data are read out from at least one external process database and measurement data are read out from at least one external technical control unit and are interlinked for visualisation, the method allows a comprehensive evaluation and visualisation of a technical process. In this case, the visualisation and evaluation is not restricted to pure process data read out from a PLC nor, for example, to purely commercial data stored in databases. Rather, according to the invention, a comprehensive evaluation of the system can be made taking into account these two types of data which are not directly linkable according to the prior art.

### BRIEF DESCRIPTION OF THE DRAWINGS

The invention is described as an example in a preferred embodiment with reference to drawings, wherein further advantageous details can be deduced from the Figures in the drawings.

Functionally the same parts are provided with the same reference numerals.

The figures in the drawings show in detail:

FIG. 1: shows a schematic diagram of a preferred embodiment of a data monitoring system according to the invention;

FIG. 2: shows a schematic diagram of a relational database structure for the standard treatment of external databases and external PLCs according to the invention;

FIG. 2b: shows a schematic diagram of the data model for linking channel data to the memory address of an external device

FIG. 3.1: shows an example of a data structure for a drive in its technical form as a component of a data monitoring system according to the invention;

FIG. 3.2: is a continuation of FIG. 3.1;

FIG. 3.3: is a continuation of FIG. 3.2;

FIG. 3.4: is a continuation of FIG. 3.3;

FIG. 3.5: is a continuation of FIG. 3.4;

FIG. 4.1: shows a schematic diagram of a data structure of an external PLC in its hardware-technical form as a component of a data monitoring system according to the invention, the diagram corresponding to those of FIGS. 3.1 to 3.5;

FIG. 4.2: is a continuation of FIG. 4.1;

FIG. 4.3: is a continuation of FIG. 4.2;

FIG. 5: shows a table to illustrate the links of parameter types and formats with an external PLC and an external database, allowed by the data monitoring system according to the invention;

FIG. 6: shows (A) a tabular overview to illustrate the addressing of a memory region of a machine control according to the invention and (B) a tabular diagram to illustrate the addressing of an external database according to the invention;

FIG. 7: shows a schematic diagram of the linking of data channels to external units (A) according to the invention for the example of a data field of a technological database and (B) for the example of a parameter of a PLC.

### DESCRIPTION OF THE PREFERRED EMBODIMENTS

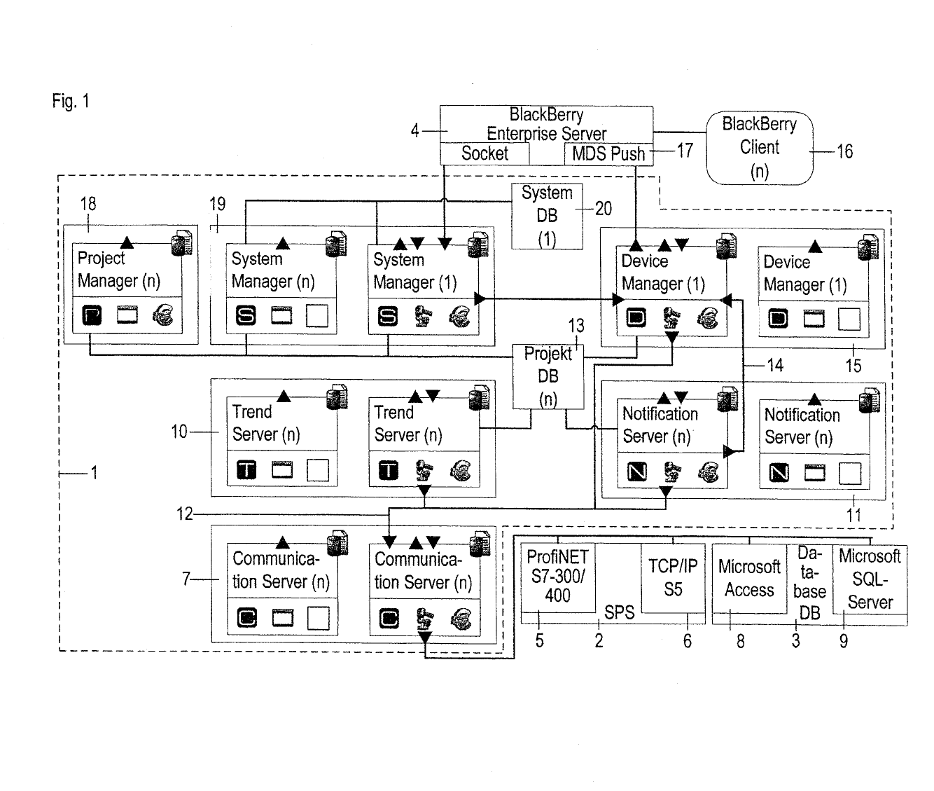

FIG. 1 shows in a schematic overview the general architecture of a system according to the invention for monitoring, control and data acquisition according to the invention. The system is designated hereinafter for simplicity as monitoring system. The monitoring system is generally designated with the reference numeral 1. The system boundaries are indicated by a dashed line in the diagram.

The monitoring system 1 is connected to a programmable logic controller (PLC) 2 and an external database 3. The person skilled in the art will appreciate that these two external units are only to be understood as exemplary. In practice, an arbitrary number of PLCs 2 and/or databases 3 can be connected to the monitoring system 1 according to the invention.

The monitoring system 1 is additionally connected via a BlackBerry service 4 for mobile communication to a mobile terminal 16, the mobile terminal 16 being set up as a BlackBerry client. The PLC 2 is connected via a system network 5 according to the Profinet standard and a TCP/IP service 6 to a communication server 7 of the monitoring system 1 according to the invention. In this way, the communication server 7 forms the connecting member between the monitoring system 1 according to the invention and the automation technology connected to the PLC 2. In distributed systems the communication server 7 can be set up directly adjacent to the automation equipment of the technical installation. This is because, according to the embodiment of the invention described here, the communication server 7 is independent of the other components of the monitoring system 1. In particular, there is no database connection.

The database 3 can, for example, be an SAP database or Microsoft Access database. The database 3 is likewise connected via a database connection 8 and an SQL server 9 to the communication server 7 of the monitoring system 1. The database connections 8, 9 are to be understood only as exemplary. The person skilled in the art will appreciate that other possibilities for data connection to the communication server also exist within the scope of the invention.

The monitoring system 1 comprises as further essential components a trend server 10 and a notification server 11. Both the trend server 10 and the notification server 11 communicate bidirectionally with an internal interface 12 of the communication server 7.

The trend server 10 is used to administer the measured values specially configured for the trend server 10 in a project. To this end, the trend server 10 indicates a determined actual value in a predetermined time interval which was received from the database 3 or the PLC 2 via the communication server 7, in a project database 13. In this case, preconfigured parameters can be taken into account for determining averages or for smoothing the measured value read out from the PLC 2 and/or database 3 when determining the actual value.

The notification server 11 administers the digital messages specially configured for the notification server 11 in a project provided for this purpose, which have been received from the PLC 2 and/or the database 3 via the communication server. The notification server functionally serves to output a message when specific data events occur. A data event in this sense can, for example, be a flank change of the measured value in question. Such a flank change is received, for example, in the notification server 11 by comparing the old value with the new value. The notification server 11 then identifies an ascending or descending flank of a message by a change from 0 to 1 or from 1 to 0. In order to fulfill this function, the notification server 11 of the monitoring system 1 according to the invention reads out the relevant memory region of the PLC 2 and/or database 3 by means of the communication server 7.

A message 14 generated by the notification server 11 is transmitted within the monitoring system 1 to a device manager service 15. The device manager service 15 is responsible for communication with mobile terminals, in particular a BlackBerry server 4. The device manager 15 therefore functions as a connecting member between the monitoring system 1 according to the invention and the BlackBerry terminals 16. Exchange of data between the device manager 15 and the BlackBerry service 4 takes place particularly by means of a PUSH service 17. As a result, messages 14 generated by the notification server 11 are transmitted via the device manager 15 after their creation directly to the BlackBerry client 16 without the BlackBerry client 16 needing to start an enquiry.

Another important service of the monitoring system 1 according to the invention is the project manager service 18 and the system manager service 19. The system manager service 19 is substantially used to connect with a system database whereas the project manager service 18 is substantially used for projecting and configuration and also for communication to the project database 13.

The data forming the project-independent framework of the monitoring system 1 according to the invention are stored in the system database 20. These include in particular, all system parameters, an overview of installed modules and project databases 13, a user/terminal administration and the central licensing of all elements. In addition, all accesses and enquiries from outside are logged in the system database 20.

The project database 13 stores all the data required by the modules in relation to a project in order to carry out their task completely and without further enquiry of the system database 20. Thus, a special instance of the elements available according to the system database 20 in the sense of an instantiation is formed in the project database 13.

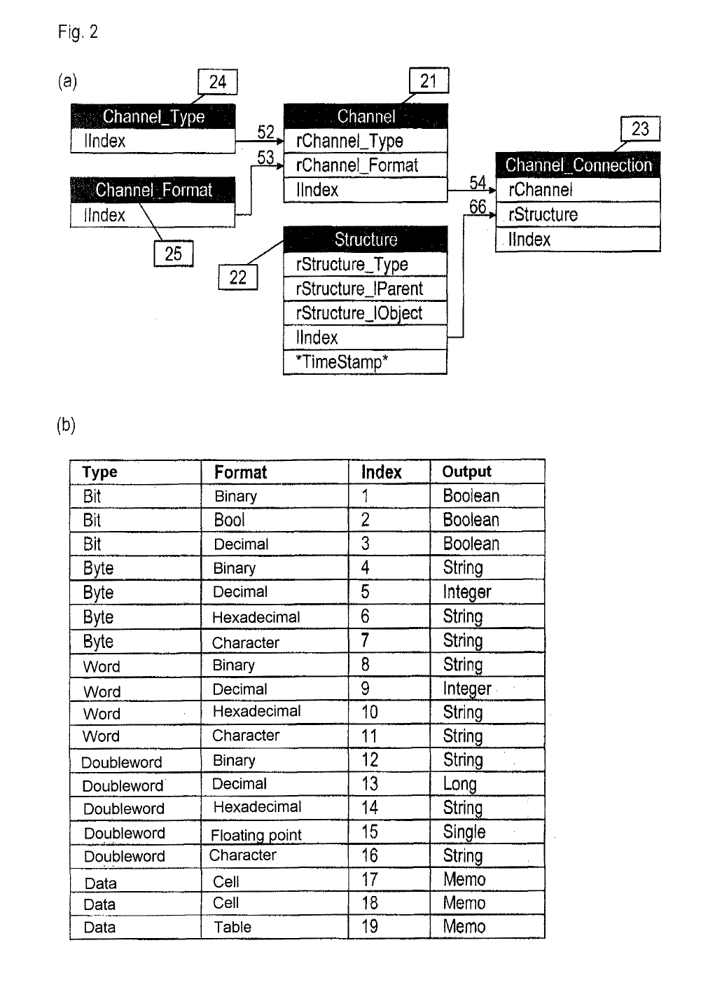

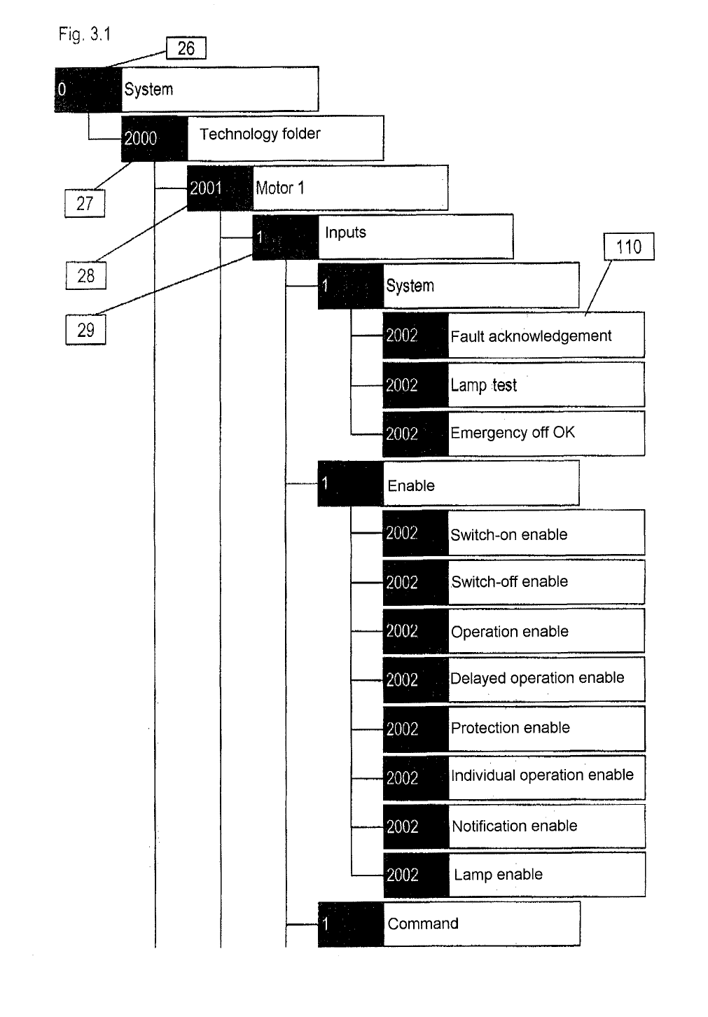

The project database 13 contains the data required for a standardised directional communication according to the invention with the PLC 2 in equal measure with the database 3. FIG. 2 illustrates the fundamental data model of a relational database whereby it is ensured according to the invention that external databases 3 and also external PLCs 2 can be incorporated uniformly into the monitoring system 1 according to the invention. At the same time, an allocation of mutually compatible data types is ensured.

The relational database shown in FIG. 2(a) is implemented in the project database 13. This comprises a channel type table 21 and a structure database 22. Links from elements in the channel type table 21 with the structure database 22 which should be allowed by the monitoring system 1 according to the invention are stored in a channel connection database 23.

All the elements of a project are stored hierarchically in the structure table 22. The available channel types as a combination of data type 24 and data format 25 are stored in the channel type table 21 which serves as a linked table. In order to allocate a channel type to a structure element, this information is added in a further linked table, said channel database 23. As illustrated in FIG. 2b, the data of this channel database 23 are connected via the linked table 108 shown there to the memory address of an external device, i.e. to a database or a PLC.

FIG. 2b shows how these memory addresses of a database or PLC are administered in detail in a project database 13.

The various database and PLC types which can be connected to the monitoring system 1 are defined in a table 101. The method by which the monitoring system 1 can communicate with these external devices is obtained from the listing 100 and the link in table 104. The available drivers of external devices 2, 3 are administered in the table 104. In order to actually set up an external device 2, 3 in the project, it is entered as an element in the structure database 22 and specified via the table 106 with the driver selection 104. The available channel resources related to the device type stored in the table 101 are independent of the driver and stored in the linked table 105.

The channel resources are obtained in relation to the external device type 2, 3 from a combination between channel group according to table 102 e.g. inputs, flags, table etc. and channel type according to table 23.

These channel resources specify the available addressable region related to the respective external device 2, 3 which results in the addressed channel in the table 107. This can be transferred in an exactly fitting manner with the parameter from 23 in the table 108 to an addressable parameter.

The channel type table 21 stores available communication channels together with data relating to the channel type and the channel format. The channel type table 21 obtains the possible values for the channel type from the channel type database 24 attached via a 1:n link. The channel type table 21 also obtains possible channel formats from the channel format database 25 likewise attached with a 1:n link.

As an example, FIG. 2(b) shows in a table a possible occupancy of the channel type table 21 according to the invention. It is apparent that in the column with the heading “type” the possible values are selected from the set bit, byte, word, double word, data. It is also apparent that in the column format, one of the values binary, boolean, decimal, hexadecimal, character, floating point, cell, table are selected.

Each of these channel types is allocated a unique index in the correspondingly headed column. An index uniquely describes an available, predefined channel type. It is apparent that a channel can therefore, as it were, define a communication with an external PLC 2 and also a communication with an external database 3. The administration and addressing within the monitoring system 1 according to the invention is in this case completely identical. In particular, no so-called media disruption occurs, as is the case in the prior art.

Data structures within a given project are stored in the structure table 22 in a folder hierarchy. The data are acquired hierarchically and can be displayed in a visualisation in a project tree. The state parameters which are possible and need to be monitored for a specified installation part of a technical installation are stored, for example, within a structure input. A structure in this sense can refer to a value read out from the PLC 2 and a value read out from the database 3.

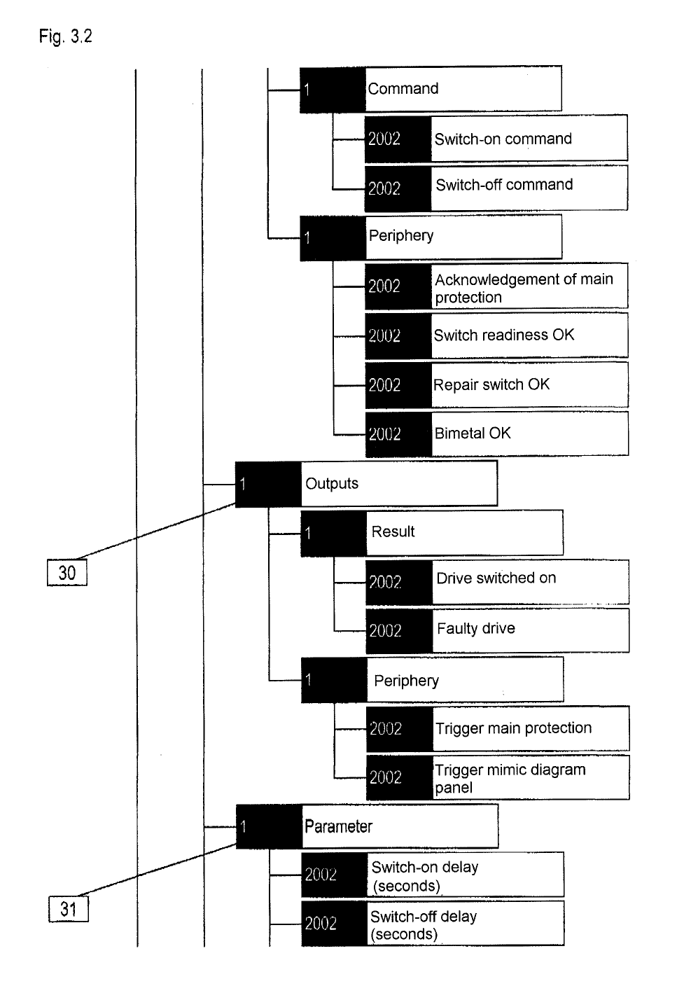

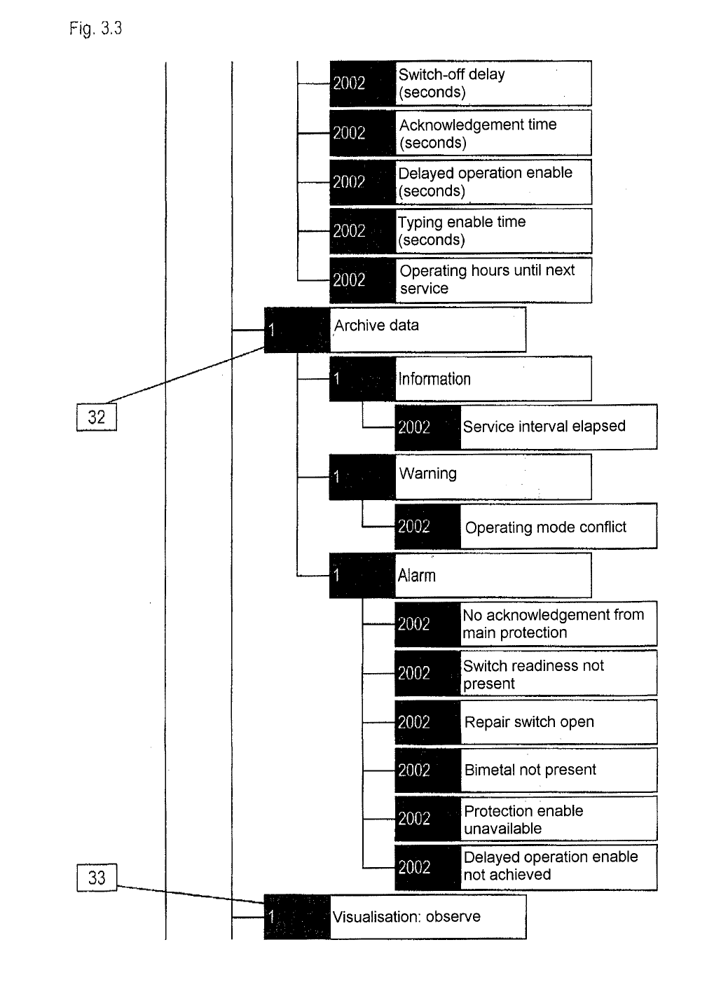

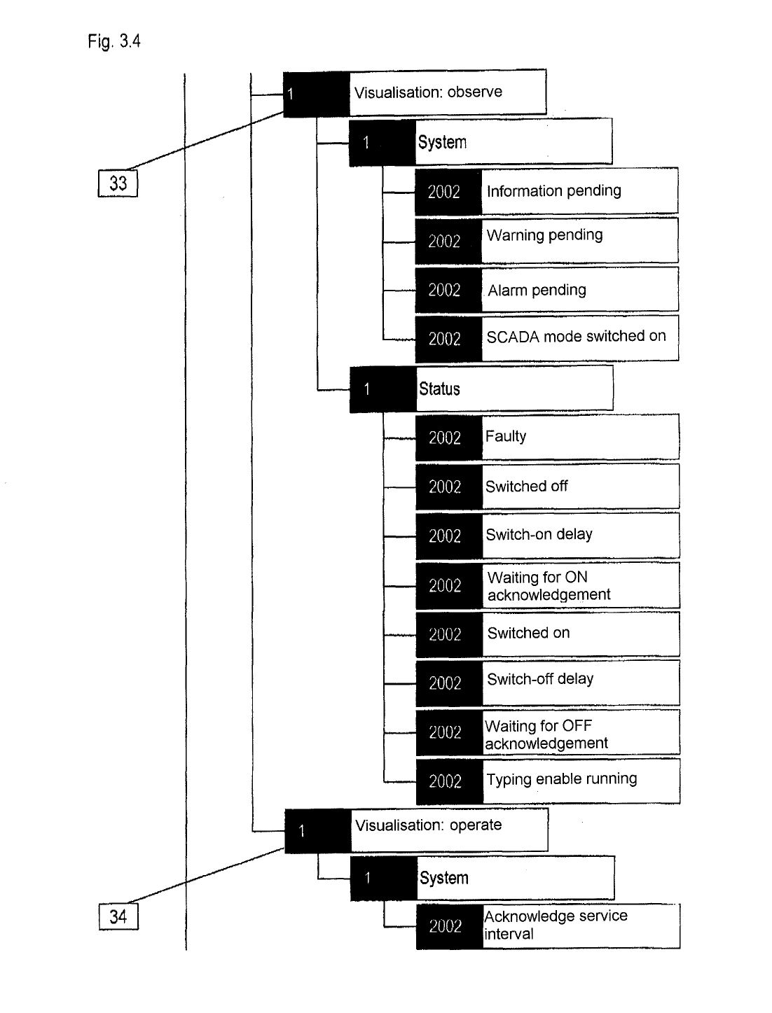

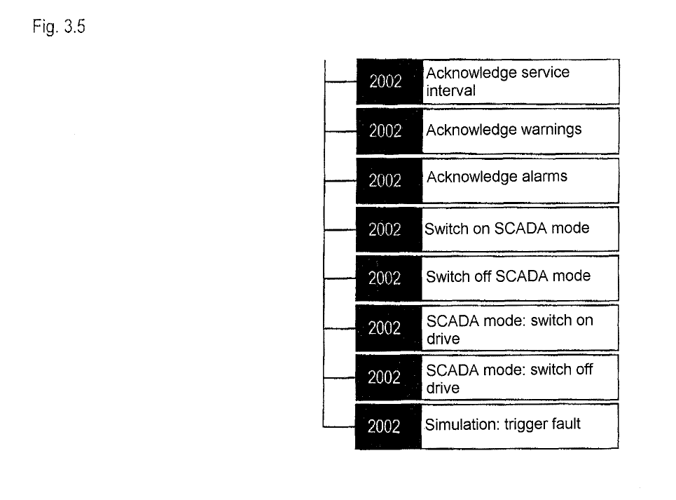

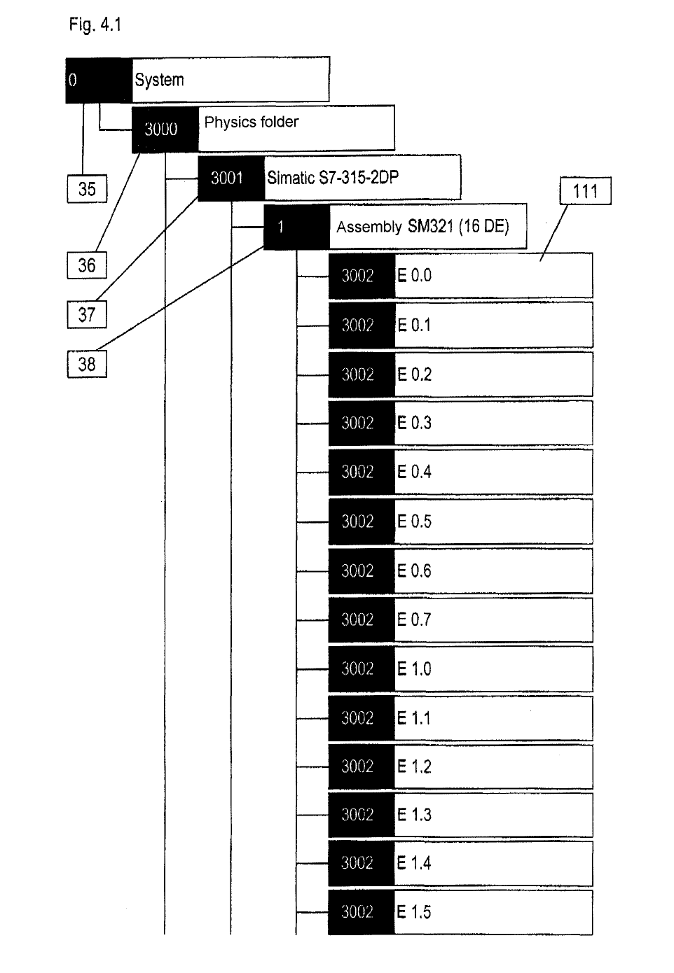

FIGS. 3.1. to 3.5 show a project tree 26 for a structure for the example of a drive. FIGS. 3.1 to 3.5 relate to the same project tree 26 and are to be interpreted as superposed on one another, wherein FIG. 3.1 is to be arranged as the highest and FIG. 3.5 as the lowest. It is apparent from FIG. 3.1 that the structure of the drive is classified in the upper category “technology” 27.

It can further be identified that the project tree 26 contains technology data 28 for a motor_1. Hierarchically classified, the technology data 28 for the motor_1 acquire data via inputs 29, outputs 30 (cf. FIG. 3.2), parameter 31, archive data 32 (cf. FIG. 3.3), a visualisation mode 33 (this is repeated for better clarity in FIG. 3.4), operating modes 34.

The inputs 29 of the motor_1 28 include a fault acknowledgement, a lamp test and an emergency-off OK. Enable values which are likewise defined as input 29 of the motor 28 comprise commands for switch-on enable, switch-off enable, operation enable, delayed operation enable, protection enable, individual operation enable, notification enable as well as lamp enable. Furthermore, input commands as a subgroup of the inputs 29 comprise a switch-on command and a switch-off command. The inputs 29 from the periphery include, according to FIG. 3.2, an acknowledgement of main protection, a switch readiness OK signal, a repair switch OK signal and a bimetal OK signal.

The outputs 30 of the motor 28 within the structure 26 of the drive include values for switch-on delay or switch-off delay in seconds (cf. FIG. 3.2) as well as an acknowledgement time, delayed operation enable time, typing enable time, in each case in seconds as well as operating hours until the next service.

The archive data 32 assigned within the structure 26 to the motor_1 28 of the drive include information about the sequence of a service interval, warnings about conflict of operating modes and alarms having the following content:
acknowledgement from main protection
switch readiness not present
repair switch open
bimetal not present
protection enable unavailable
delayed operation enable not achieved

The visualisation modes 33 include data in relation to the system as to whether information is pending, a warning is pending, an alarm is pending or an SCADA mode is switched on. The status messages in this category include the following status messages:
faulty
switched off
switch-on delay
waiting for ON acknowledgement
switched on
switch off delay
waiting for OFF acknowledgement
typing enable running.

The operating modes 34 according to FIGS. 3.4 and 3.5 include the following operating commands:
acknowledge service interval
acknowledge warnings
acknowledge alarms
switch on SCADA mode
switch off SCADA mode
SCADA mode: switch on drive
SCADA mode: switch off drive
simulation: trigger fault

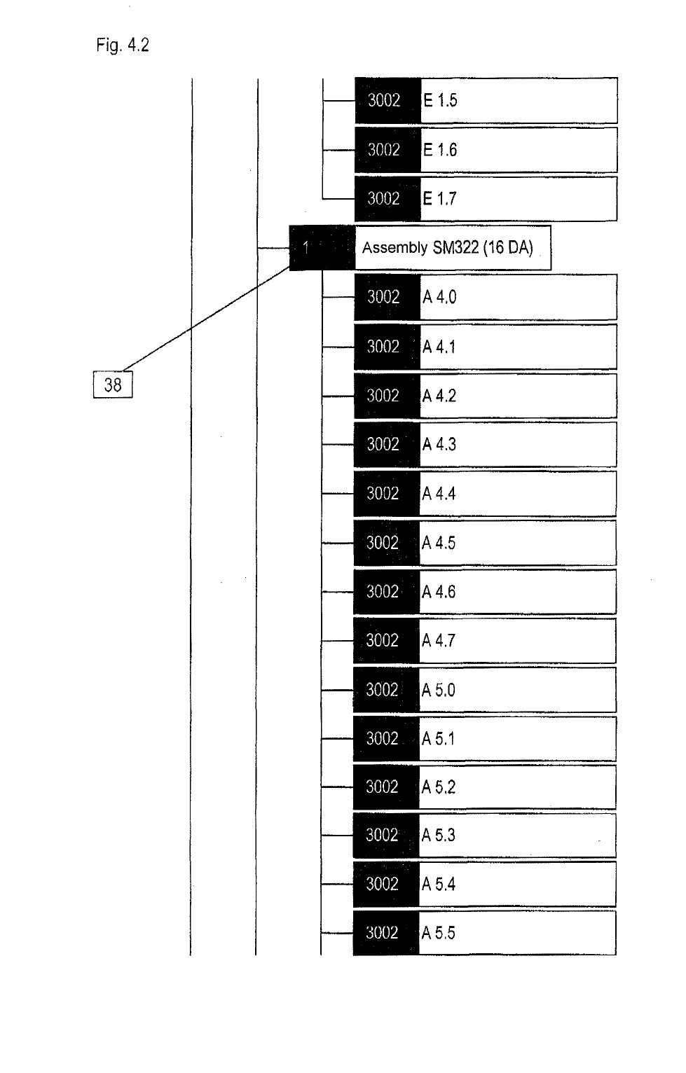

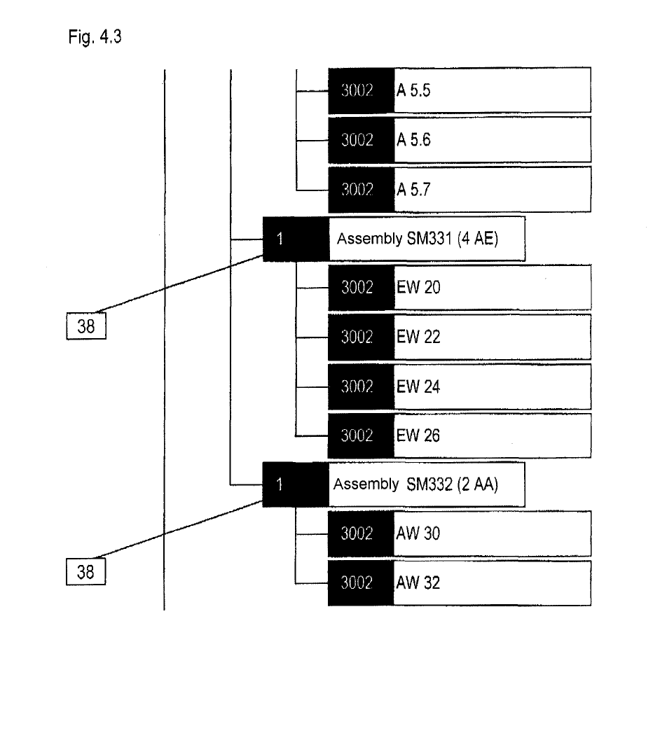

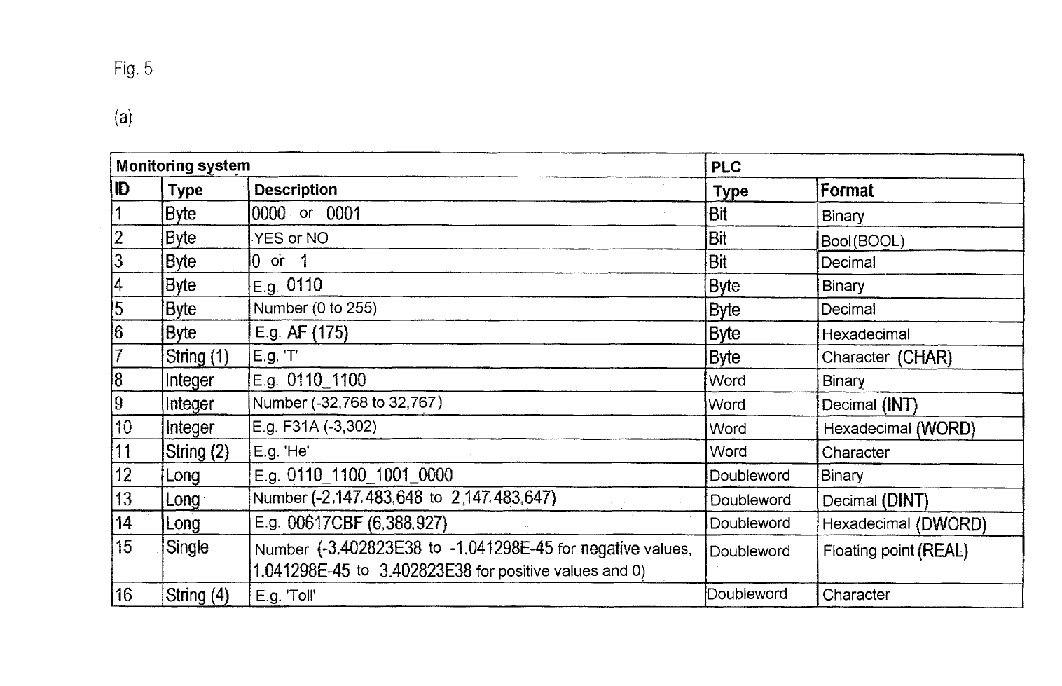

The FIG. 4.1 show as an example a project tree 35 for linking to the PLC 2. The relationship of FIGS. 4.1 to 4.3 is to be interpreted similarly to that of FIGS. 3.1 to 3.5. The figures are therefore to be interpreted as arranged one above the other.

As can be seen in FIG. 4.1, the structure 35 of the project tree of the PLC 2 is allocated to the folder category 36 “Physics”. According to this exemplary embodiment, parameters which can be read out from the PLC 2 can be stored in this folder. Technology data 37 of an exemplary PLC 2 with the designation “Simatic S7-315-2DP” are stored within the folder category 36 for physics. For this Simatic PLC, readable parameters E 0.0 . . . E 1.7 or A 4.0 . . . A 5.7 or EW 20 EW 26 or AW 30 AW 32 are defined there for four different assemblies 38.

With reference to FIG. 2, it is now illustrated how an allocation of one of the predefined project trees 26, 35 within the structure database 22 to a compatible data channel is made according to the channel type table 21. By this means it is ensured according to the invention that only data compatible in terms of data form are assigned to one another. In addition, only the previously defined values are read out and interrogated by the external units, i.e. the PLC 2 and the database 3. According to the invention, the processing of the signals is independent of whether the source is the PLC 2 or the database 3.

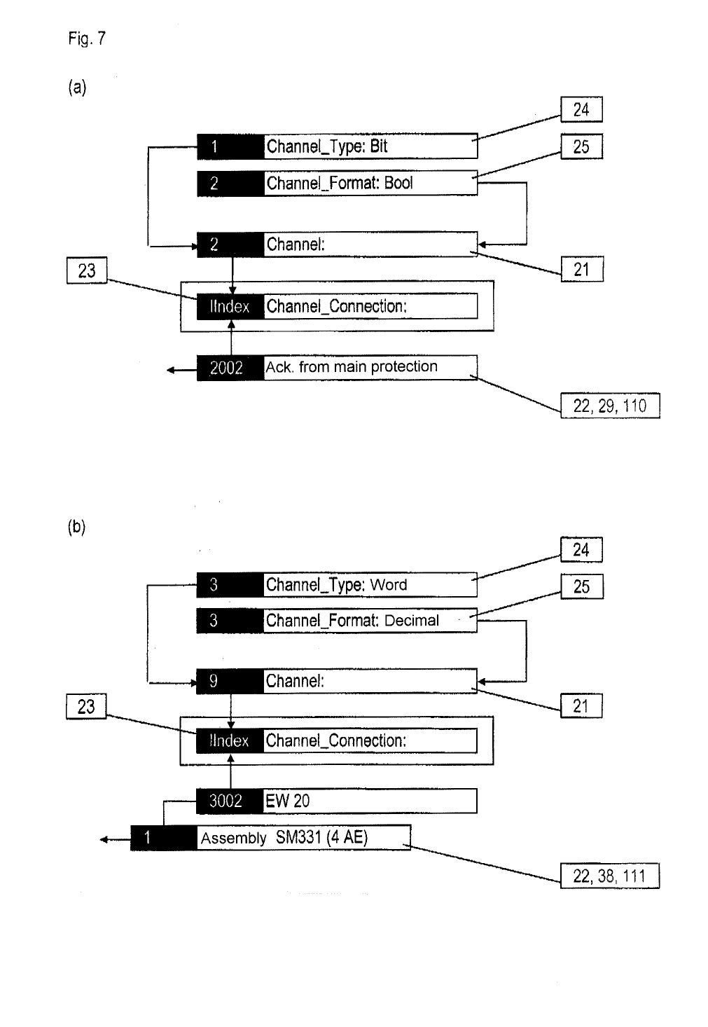

FIG. 7 additionally illustrates graphically the process of allocating a data channel to a structure according to FIGS. 2(a) and 2(b). In FIG. 7(a), this allocation is shown for the example of a technological parameter. In detail, the parameter cknowledgement main protection in the periphery folder of the inputs 29 of the folder for technology data 28 in FIG. 3.2 is connected to a suitable channel.

For this purpose, the element BIT from the channel database 24 and the element BOOL from the channel format database 25 is selected as a combination in the channel type table 2 in order to designate a channel type BIT with the format BOOL. According to FIG. 2(b) this channel has the index 2 within the channel type table 21. This channel 2 of the channel type table 21 is now linked in the channel connection table 23 to the parameter cknowledgement main protection of the corresponding structure element of the corresponding structure database 22. This means that the corresponding data channel from the channel type table 21 is allocated to a message cknowledgement main protection in BOOL format, which is read out from an external data system as input. A correct allocation and evaluation of the parameter cknowledgement main protection is thus ensured in the monitoring system 1 according to the invention.

In corresponding manner, FIG. 7b shows as an example how a parameter EW 20 of the assembly SM33 according to the structure 35 from FIGS. 4.1 to 4.3 is allocated to a channel of the type word in decimal form within the channel connection table 23.

The channel thus comprises a word, this value is to be displayed as a decimal number.

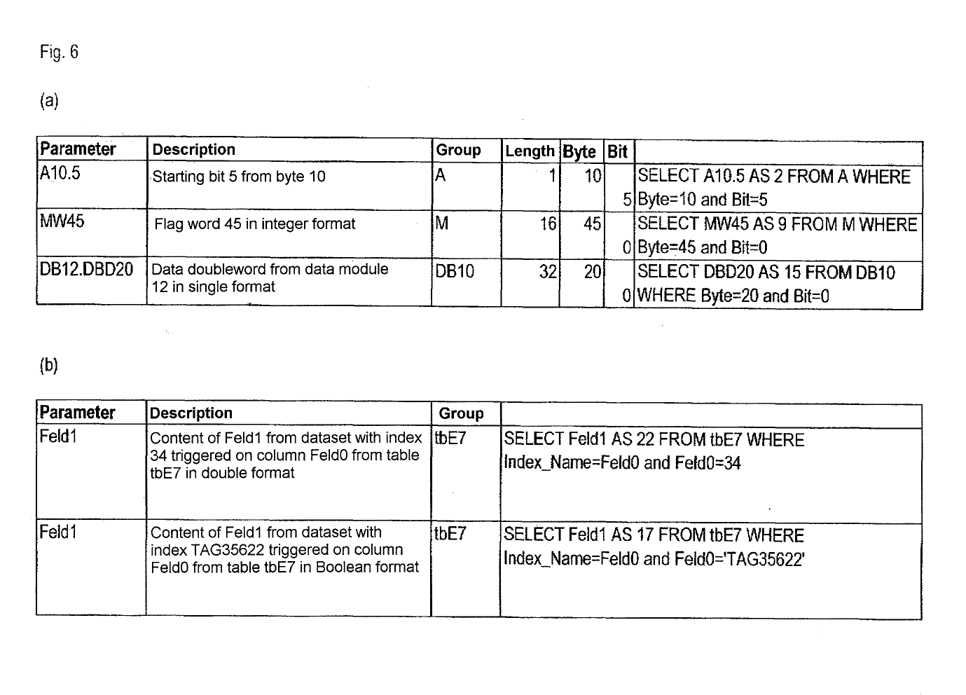

With reference to two examples, FIG. 6 explains how memory regions of external units are addressed in standardised form according to the invention using the method according to the invention or by the control according to the invention. According to FIG. 6a the addressing of parameters of the PLC 2 is illustrated in tabular form. The SQL command:

SELECT A 10.5 AS 2 FROM A WHERE Byte=10 and Bit=5

is used to read out a parameter A 10.5 (cf. also the structure 35) which relates to the output bit number 5 from byte number 10 and which belongs to group A having a length 1.

Apart from the use of SQL explained here as an example, SQL-like languages can also be used for example.

Similarly, the parameter MW 45 which contains the flag word 45 in integer format is also read out with the eight-digit SQL command:

SELECT MW45 AS 9 FROM M WHERE Byte=45 and Bit=0.

Finally, as shown in column 3 of the table according to FIG. 6a, the parameter DB12.DBD20, i.e. a data double word from data module 12 in single format is read out with the SQL command reproduced hereinafter:

SELECT DBD20 AS 15 FROM DB10 WHERE Byte=20 and Bit=0.

FIG. 6(a) illustrates in tabular form with reference to two examples the addressing of parameters from the database 3 which is connected to the monitoring system 1 according to the invention. The SQL command:
SELECT Feld1 AS 22 FROM tbE7 WHERE
Index_Name=Feld0 and Feld0=34

is used for reading out the parameter eld1 which therefore relates to the content of the field 1 from the dataset with the index 34, triggered on column Feld0 from the table tbE7 in double format:

Likewise, the SQL command:
Select Feld1 AS 22 FROM tbE7 WHERE
Index_Name=Feld0 and Feld0=AG35622
   is used for reading out the content of Feld1 from the dataset with the index TAG35622, triggered on column Feld0 from Table tbE7 in Boolean format.

It can thus be seen that the addressing of the database 3 proceeds completely according to the same syntax as the addressing of PLC 2. This is possible thanks to the structure database 22 stored in the project database 13 and its linking to the channel type table 21 in the channel connection database 23. In this case, it has been taken into account that the address of a parameter within a programmable logic controller (PLC) is constructed as follows: group, length, byte, bit.

In general, the standard syntax used according to the invention for addressing memory regions of various connected devices is as follows:

SELECT Cell Format_ID FROM Page WHERE.

Cell stands for the name of the parameter, Format_ID for the combination of type and format obtained from the unique relation index, Page for the region, the group or table in which the parameter lies and Rule for the rule as to how the parameter is to be uniquely addressed on the page.

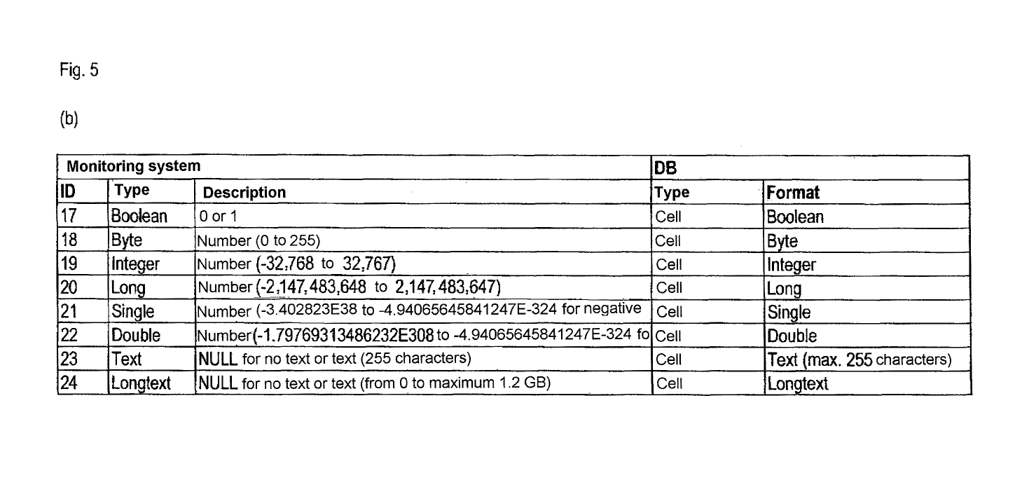

FIG. 5 finally gives a table which gives information on which parameter types and formats can be connected to external devices with the system and method according to the invention according to a preferred exemplary embodiment.

In FIG. 5a the corresponding overview is shown in relation to the PLC 2. The connection parameters on the part of the monitoring system 1 according to the invention relate to the first three columns in the table, that is the columns ata type ata format epresentation The two right-hand columns, i.e. columns 4 and 5 relate to type and format of the respective external device.

In FIG. 5a the external device is the PLC 2. The index column gives the unique channel number according to the channel definition table 21. Column 2 gives the data type, column 3 gives the representation within the monitoring system 1. Columns 4 and 5 describe type and format of the linked PLC parameters.

FIG. 5(b) shows the table similar to FIG. 5(a). Unlike FIG. 5(a), the table in FIG. 5(a) shows the definition during the translation of formats of the monitoring system according to the invention with the database 3.

Thus, according to the invention a system and method for the monitoring, control and data acquisition of technical processes is proposed which allows a standardised monitoring and evaluation of external devices. External devices can be both programmable logic control (PLC) and external databases. The simultaneous monitoring of databases and PLCs with the same system 1 is easily possible according to the invention.

Bidirectional data exchange is possible with the external databases and PLCs. The system is capable of communicating bidirectionally with mobile BlackBerry clients via the BlackBerry service. It is therefore possible within the scope of the invention to control and monitor a technical installation at a remote location via a mobile BlackBerry client. The BlackBerry client can access data from external databases and also parameters read out from external PLCs.

### Reference List

1 Monitoring system
2 Programmable logic control (PLC)
3 Database
4 BlackBerry service
5 ProfiNET installation network
6 TCP/IP service
7 Communication server
8 Database application
9 SQL server
10 Trend server
11 Notification server
12 Internal interface
13 Project database
14 Message
15 Device manager service
16 BlackBerry client
17 PUSH service
18 Project manager service
19 System manager service
20 System database
21 Channel type table
22 Structure database
23 Channel connection database
24 Data type
25 Data format
26 Project tree database
27 Subfolder in the project structure for holding technological relationships
28 Technology data
29 Inputs
30 Outputs
31 Parameter
32 Archive data
33 Visualisation mode
34 Operating modes
35 Project tree PLC
36 Subfolder in the project structure for holding physical relationships (hardware)
37 Technology data
38 Subfolder which divides the physical unit 37 into assemblies
100 List of usable connection protocols for communication with external devices
101 List of usable process connection types
102 List of usable channel regions and/or memory regions
104 Connection table in which the usable combinations of type and protocol of a process connection are defined
105 Valid memory regions of a process connection used for the specific addressing of a parameter or periphery channel for checking availability
106 Connection table in which the usable combinations of type and protocol of process connections are allocated their valid memory regions
107 Specific address of a process connection
108 Connection table between the technological channel and a specific address of a process function
110 Parameter (data class 2002) to which a channel type 23 can be assigned
111 Periphery channel (data class 3002), to which a channel type 23 can be assigned

1. A system (1) for monitoring, control and data acquisition of technical processes, comprising at least one communication unit (12) as an interface for bidirectional data exchange with external units (2, 3), characterised in that at least one communication unit (12) is configured for communication with at least one external electronic process database (3) and at least one communication unit (12) is configured for communication with at least one external technical control unit (2).

2. The system (1) according to claim 1, characterised in that the communication unit (12) is configured for addressing any external unit (2, 3) by means of a unique identifier, wherein identifiers for process databases (3) are configured to be referencing to their primary key and identifiers for control units (2) are configured to be referencing to a memory address.

3. The system (1) according to claim 1, characterised in that a communication channel database (21, 24, 25, 102, 104, 105, 106, 107) is provided in which identifiers for communication with external units (2, 3) are stored.

4. The system (1) according to claim 1, characterised in that the communication unit (12) is configured for addressing memory regions on external units (2, 3) according to a standard format for all external units (2, 3), in particular SQL format.

5. The system (1) according to claim 1, characterised in that a data structure database (22) is provided, in which data structures (26, 27, 28, 29, 35, 36, 37, 38) of external units (2, 3) connectable to the system are stored.

6. The system (1) according to claim 1, characterised in that means for checking a data compatibility, in particular with regard to a data format and/or a data width, are provided between elements of the data structure database (22) and elements of the communication channel database (21, 24, 25, 102, 104, 105, 106, 107).

7. The system (1) according to claim 1, characterised in that a connection database (23) is provided in which desired compatible pairs of elements of the data structure database (22) and elements of the communication channel database (21, 24, 25, 102, 104, 105, 106, 107) are stored.

8. The system (1) according to claim 1, characterised in that a link database is provided for storing links between process data from a process database (3) and measurement data from a technical control unit (2) for the purpose of visualising said data.

9. A method for monitoring, control and data acquisition of technical processes by means of bidirectional data exchange with external units (2, 3), characterised in that data exchange is carried out with at least one external electronic process database (3) and at least one external technical control unit (2).

10. The method according to claim 9, characterised in that each external unit (2, 3) is addressed by means of a unique identifier, wherein identifiers for process databases (3) are formed from their primary key and identifiers for control units (2) are formed from a memory address.

11. The method according to claim 9, characterised in that identifiers for data exchange with external units (2, 3) are stored before the beginning of monitoring, control and data acquisition in a communication channel database (21, 24, 25, 102, 104, 105, 106, 107).

12. The method according to claim 9, characterised in that memory regions on external units (2, 3) are addressed according to a standard format for all external units (2, 3), in particular SQL format.

13. The method according to claim 9, characterised in that before each data exchange at least one data structure (26, 27, 28, 29, 35, 36, 37, 38) of external units (2, 3) connectable to a system (1) is read out from a data structure database (22) and before each data exchange, a data compatibility, particularly with regard to a data format and/or a data width, is checked between elements of a data structure database (22) and elements of a communication channel database (21, 24, 25, 102, 104, 105, 106, 107), wherein a data exchange is exclusively carried out between compatible elements.

14. The method according to claim 9, characterised in that process data are read out from at least one external process database (3) and measurement data are read out from at least one external technical control unit (2) and are interlinked for visualisation.
